(19) United States
(12) Patent Application Publication
(10) Pub. No.: US 2014/0218295 A1
(43) Pub. Date: Aug. 7, 2014

(54) COMPUTER MOUSE HAVING A CAPACITIVE TRIGGER LAYER

(71) Applicant: Yung-Lung Liu, Taichung City (TW)

(72) Inventor: Yung-Lung Liu, Taichung City (TW)

(73) Assignee: SUNREX TECHNOLOGY CORP., Taichung City (TW)

(21) Appl. No.: 13/758,024

(22) Filed: Feb. 4, 2013

(51) Int. Cl. G06F 3/033

(52) U.S. Cl. CPC G06F 3/033
USPC 345/163

(57) ABSTRACT

A computer mouse is provided with a curved cover, an operating zone formed on an outer surface of the cover, and a capacitive trigger layer formed on an inner surface of the cover, the capacitive trigger layer including first and second sensors arranged in matrix, the first sensors arranged perpendicular to the second sensors, and the sensors corresponding to the operating zone so that a touch of the operating zone changes capacitances of the sensors to generate a touch signal; a PCB disposed on the base and including a controller for processing and transmitting the touch signal, and a photo-sensing assembly for sensing reflected light, generating a signal representing the reflected light, and processing the reflected light signal; and a base complementarily, detachably secured to the cover, and a light guide for directing and converging light disposed on the base.

### BACKGROUND OF THE INVENTION

1. Field of the Invention

The invention relates to computer mice and more particularly to a computer mouse having a capacitive trigger layer on an inner surface of a cover formed by sputtering.

2. Description of Related Art

Computer mice are well known peripherals for personal computers. A computer mouse is a pointing device held under the hand and functions by detecting two-dimensional motions of the pointing device relative to its supporting surface. The mouse's motion translates into a motion of a pointer (i.e., cursor) on a display of the computer. Conventionally, a mechanical or opto-mechanical computer mouse has rollers and one, two, or even more buttons. Still conventionally, the computer mouse has a scroll wheel projecting out of its cover.

However, so far as the inventor is aware, no virtual keys having characters or functions keys printed thereon are provided in any type of computer mouse. Moreover, no small projections for guiding purposes are provided on a cover of any type of computer mouse. Hence, users may have difficulties of manipulating a computer mouse in a dark environment.

U.S. Pat. No. 8,269,723 discloses a computer mouse which has the same inventor as the present application. The US Patent is characterized by that a flexible printed circuit board (FPCB) is disposed under a capacitance trigger assembly. However, flexibility of the FPCB has a limit and stress may be concentrated on some portions thereof. And in turn, it may cause difficulties in positioning when the FPCB is assembled in the curved cover of the computer mouse. Moreover, it may cause short circuit in the bending portions. In addition, it can greatly decrease sensitivity. To the worse, it can hinder the assembly and cause inconvenience in use.

Notwithstanding the prior art, the invention is neither taught nor rendered obvious thereby.

### SUMMARY OF THE INVENTION

It is therefore one object of the invention to provide a computer mouse comprising a cover, a capacitive trigger layer, a PCB, and a base, wherein the cover is curved, an operating zone is formed on an outer surface of the cover, and a capacitive trigger layer is formed on an inner surface of the cover by sputtering, the capacitive trigger layer includes a plurality of first and second sensors arranged in matrix, the first sensors being arranged along X-axis and the second sensors being arranged along Y-axis, and the first and second sensors corresponding to the operating zone in terms of location so that a touch of the operating zone changes capacitances of the first and second sensors to generate a touch signal; the PCB is disposed on the base and under the cover, the PCB includes a controller for processing and transmitting the touch signal, and a photo-sensing assembly for sensing reflected light, generating a signal representing the reflected light, and processing the reflected light signal; and the base is complementarily, detachably secured to the cover, and a light guide for directing and converging light is disposed on a top surface of the base.

The above and other objects, features and advantages of the invention will become apparent from the following detailed description taken with the accompanying drawings.

### BRIEF DESCRIPTION OF THE DRAWINGS

FIG. 1 is a perspective view of a first preferred embodiment of computer mouse according to the invention;

FIG. 2 is an exploded view of the computer mouse of FIG. 1;

FIG. 3 is a plan view of the capacitive trigger layer of FIG. 1;

FIG. 4 is a longitudinal sectional view of the computer mouse of FIG. 1;

FIG. 5 is a perspective view of a second preferred embodiment of computer mouse according to the invention; and

FIG. 6 is a perspective view of a third preferred embodiment of computer mouse according to the invention.

### DETAILED DESCRIPTION OF THE INVENTION

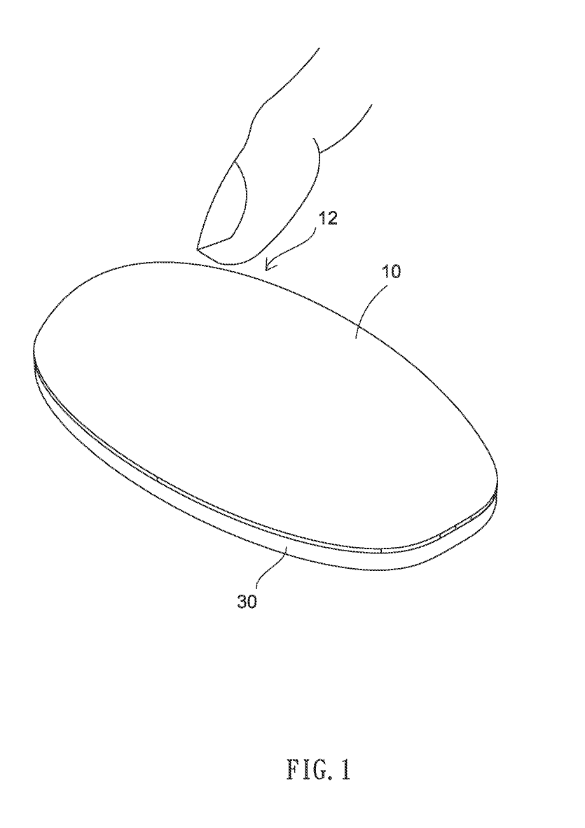

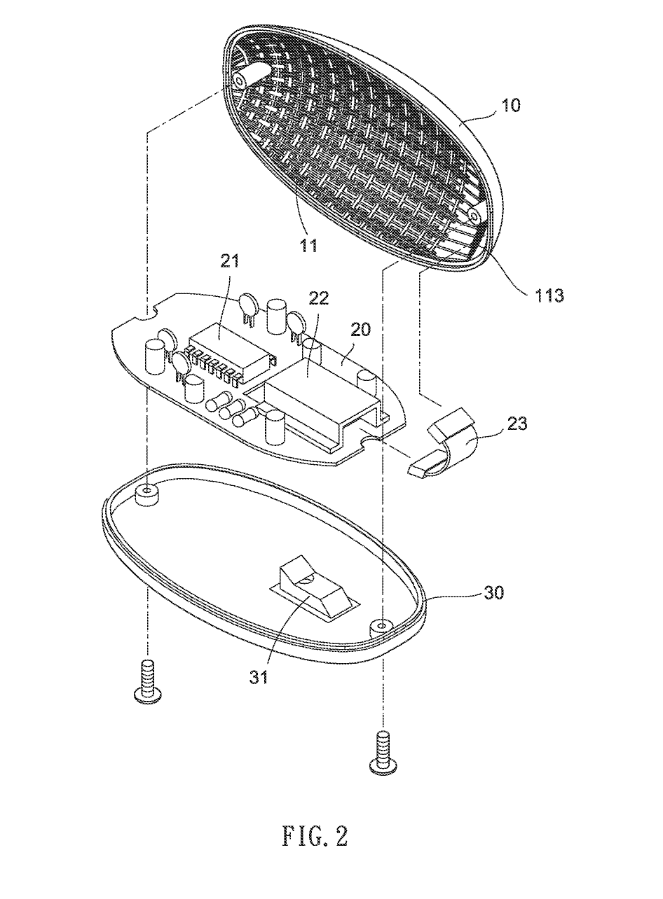

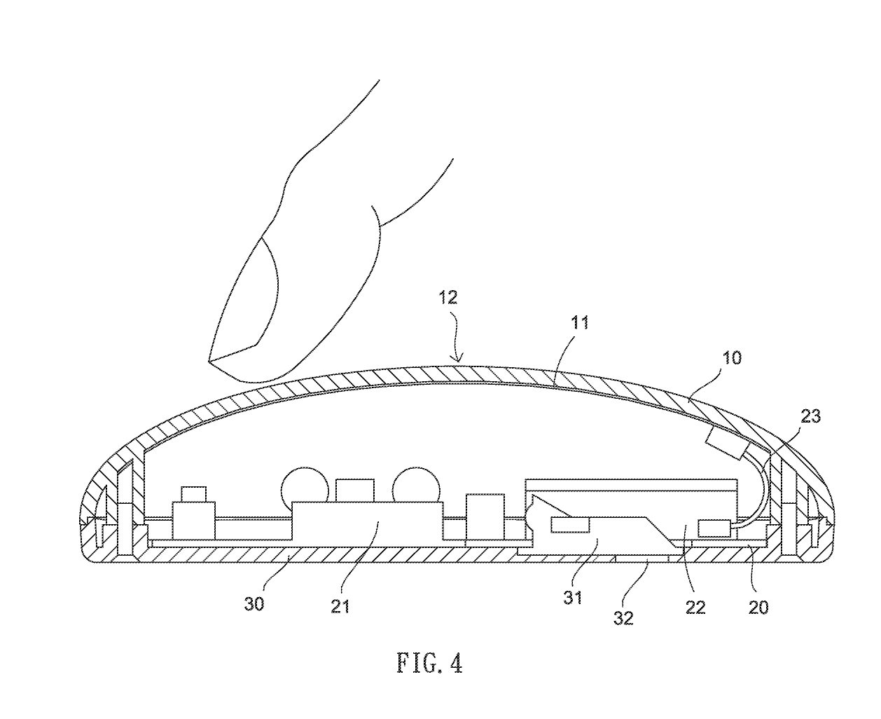

Referring to FIGS. 1 to 4, a computer mouse in accordance with the invention comprises the following components as discussed in detail below.

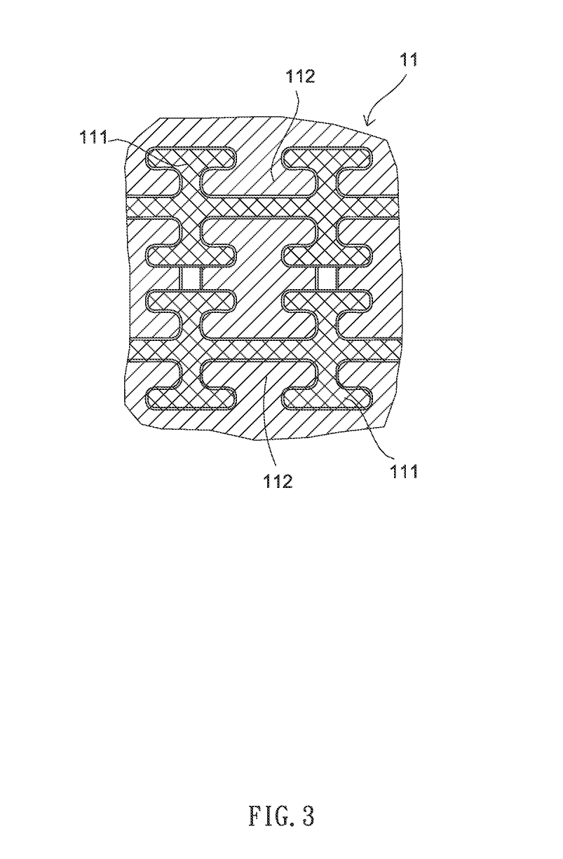

A curved cover 10 has an ergonomic surface. An operating zone 12 is formed on an outer surface of the cover 10. A capacitive trigger layer 11 is formed on an inner surface of the cover 10 by sputtering. The capacitive trigger layer 11 comprises a plurality of first and second sensors 111 and 112 arranged in matrix and formed by subjecting to ablation. The first sensors 111 are arranged along X-axis and the second sensors 112 are arranged along Y-axis (see FIG. 3). The first and second sensors 111 and 112 correspond to the operating zone 12 in terms of location. Thus, a touch of the operating zone 12 by the finger can change capacitances of the first and second sensors 111 and 112 and in turn generates a touch signal. It is envisaged by the invention that the invention can carry out left button clicking, right button clicking, key pressing, or scroll wheel scrolling and even a multi-point touch. The capacitive trigger layer 11 further comprises a contact 113 at one end. The contact 113 is electrically connected to a printed circuit board (PCB) 20 via a bus 23. Thus, the touch signal can be sent from the capacitive trigger layer 11 to the PCB 20 for further processing.

The PCB 20 is provided on an oval base 30 and under the cover 10. The PCB 20 comprises a controller 21 for processing and transmitting the touch signal, and a photo-sensing assembly 22 including a light-emitting diode (LED) as a light source and a photo-sensing member for sensing reflected light, generating a signal representing reflected light, and processing the reflected light signal. Both the LED and the photo-sensing member are known devices. Thus, a detailed description thereof is omitted herein for the sake of brevity.

The base 30 is complementarily, detachably secured to the cover 10. A light guide 31 for directing and converging light is provided on a top surface of the base 30. An opening 32 is formed on the base 30 directly below the light guide 31. Thus, the light guide 31 may guide light emitted by the LED of the photo-sensing assembly 22 to a desktop via the opening 32. Further, light reflected from the desktop may be sensed by the photo-sensing member of the photo-sensing assembly 22 via the opening 32 and the guidance of the light guide 31. The photo-sensing assembly 22 then activates a signal processing circuit to process the reflected light to generate a light signal and calculate a movement of the mouse relative to the desktop per unit time. As an end, the signal processing circuit generates a cursor control output which is in turn translated into a motion of a cursor on a display of a computer by the PCB 20.

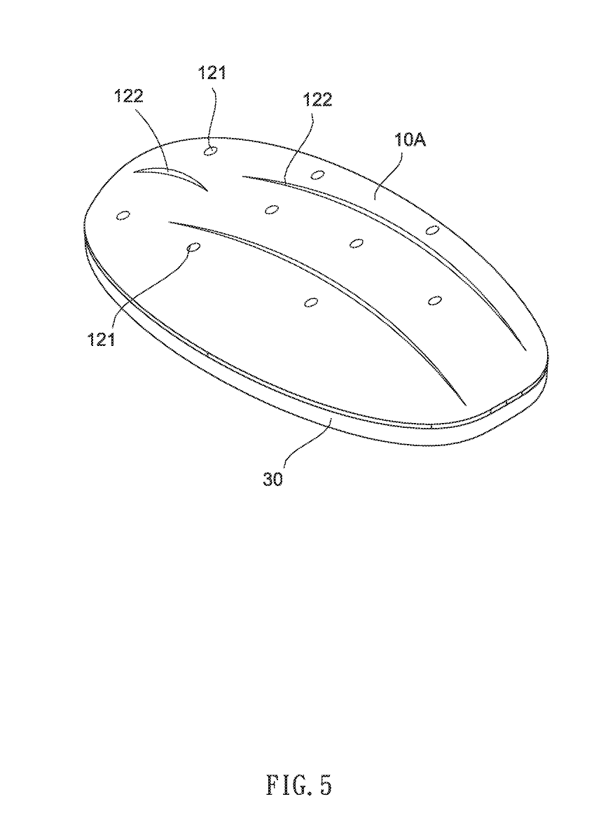

Referring to FIG. 5, a computer mouse in accordance with a second preferred embodiment of the invention is shown. The characteristics of the second preferred embodiment are detailed below.

A plurality of small projections 121 and a plurality of ribs 122 are formed on the cover 10A. The projections 121 have oblique lines or curves formed thereon so that the projections 121 may form a pattern for guiding purposes. A pressing of the projection 121 by the finger can trigger an action similar to that of a typical computer mouse button clicking. The ribs 122 also serve as touch guide. A pressing of the rib 122 by the finger can trigger a predetermined touch zone of the cover 10A and in turn it triggers a similar to that of a typical computer mouse button clicking.

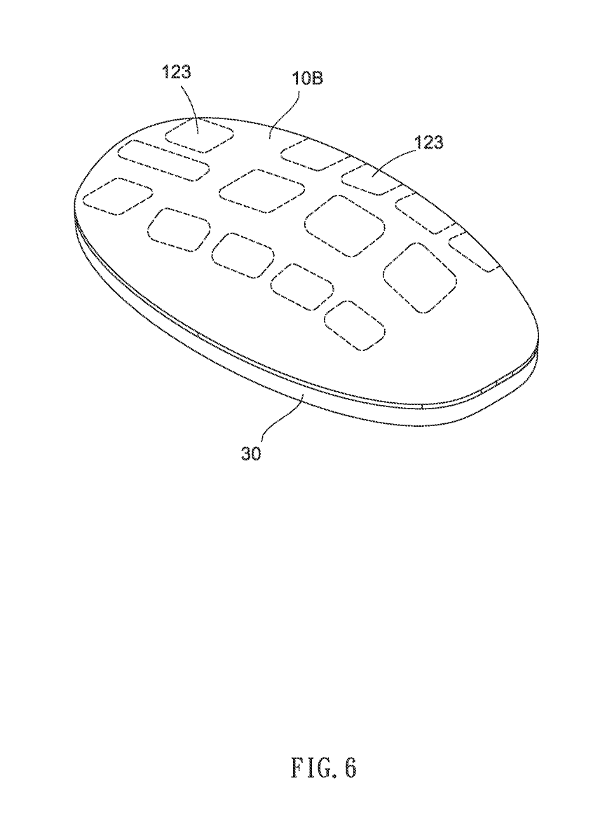

Referring to FIG. 6 in conjunction with FIGS. 1 to 4, a computer mouse in accordance with a third preferred embodiment of the invention is shown. The characteristics of the third preferred embodiment are substantially the same as that of the second preferred embodiment except the following:

The plurality of small projections and the plurality of ribs are eliminated. A plurality of rectangular virtual keys 123 with printed characters or function keys are provided on a top surface of the cover 10B. The virtual keys 123 are aligned with the first and second sensors 111, 121 therebelow. Thus, the computer mouse of the invention can operate as a typical computer keyboard having characters and function keys. Moreover, the virtual keys 123 having the characters or function keys printed thereon are formed of an optical transmissive material. Also, the capacitive trigger layer 11 is formed of an optical transmissive material. Hence, a user may easily operate the computer mouse in a dark environment because light emitted by the light source of the mouse can be directed to the virtual keys 123 through the capacitive trigger layer 11 for illumination in backlight. In brief, features of a typical mouse and numeral keys and function keys of a typical keyboard are incorporated into the computer mouse of the invention.

The invention has the following advantages. A capacitive trigger layer is formed on an inner surface of a cover by sputtering so that assembly can be made easy and touch sensitivity can be greatly increased. It can function as typical computer mouse button clicking or scroll wheel scrolling. Further, multi-point touch of a computer mouse can be carried out. A plurality of rectangular virtual keys with printed characters or function keys are provided on the cover to be used as indication means such that pressing the virtual keys may have the effects of conventional keyboard key-in or function keys. A photo-sensing assembly is provided on a PCB for generating a cursor control output. Ribs and small projections are formed on the cover as touch guide. Backlight is provided to help people operate the computer mouse in a dark environment. Further, the backlight arrangement can assist people (e.g., senior citizens or people having poor eyesight) to operate the computer mouse in a dark environment.

While the invention has been described in terms of preferred embodiments, those skilled in the art will recognize that the invention can be practiced with modifications within the spirit and scope of the appended claims.

What is claimed is:

1. A computer mouse comprising a cover, a capacitive trigger layer, a printed circuit board (PCB), and a base, wherein:
the cover is curved, an operating zone is formed on an outer surface of the cover, and a capacitive trigger layer is formed on an inner surface of the cover by sputtering, and the capacitive trigger layer includes a plurality of first and second sensors arranged in matrix, the first sensors being arranged along X-axis and the second sensors being arranged along Y-axis, and the first and second sensors corresponding to the operating zone in terms of location so that a touch of the operating zone changes capacitances of the first and second sensors to generate a touch signal;
the PCB is disposed on the base and under the cover, the PCB includes a controller for processing and transmitting the touch signal, and a photo-sensing assembly for sensing reflected light, generating a signal representing the reflected light, and processing the reflected light signal; and
the base is complementarily, detachably secured to the cover, and a light guide for directing and converging light is disposed on a top surface of the base.

2. The computer mouse of claim 1, further comprising a plurality of projections or ribs formed on the cover, the projections having oblique lines or curves formed thereon so that the projections form a pattern for guidance.

3. The computer mouse of claim 1, wherein the capacitive trigger layer further comprises a contact at one end, and a bus for electrically interconnecting the PCB and the contact.

4. The computer mouse of claim 1, further comprising a plurality of virtual keys with printed characters or function keys formed on the top surface of the cover, the virtual keys being aligned with the first and second sensors therebelow.

5. The computer mouse of claim 4, wherein the virtual keys having the characters or the function keys are formed of an optical transmissive material, and wherein the capacitive trigger layer is formed of an optical transmissive material.
